(19) United States
(12) Patent Application Publication
(10) Pub. No.: US 2008/0280268 A1
(43) Pub. Date: Nov. 13, 2008

(54) TOY SYSTEM FOR TEACHING A LANGUAGE

(75) Inventors: Miriam Kelley, Buffalo, NY (US); William J. Maloney, II, East Aurora, NY (US); Francine Needham, Orchard Park, NY (US)

Correspondence Address: EDELL, SHAPIRO & FINNAN, LLC, 1901 RESEARCH BOULEVARD, SUITE 400, ROCKVILLE, MD, 20850, US

(73) Assignee: MATTEL, INC., El Segundo, CA (US)

(21) Appl. No.: 11/746,295

(22) Filed: May 9, 2007

(51) Int. Cl. G09B 19/00; A63H 3/00

(52) U.S. Cl. 434/156; 446/268

(57) ABSTRACT

A language teaching toy system includes a base configured as an environment theme in which a user would have a particular conversation. The language teaching toy system also includes a plurality of accessories similarly configured for use in role play with the base. The base includes an identifier such that when an accessory is associated with the identifier, the identifier can generate identifying information to determine which accessory is being associated with the base. An electronic controller can receive the identifying information from the identifier and can send an output to a speaker to announce a word associated with the particular accessory in a first language then in a second language.

### BACKGROUND OF THE INVENTION

The present invention relates to a system for teaching a new language. One way to learn a new language is to experience or practice the language in an environmental situation where the language is naturally spoken. In other words, one way to learn a language (such as Spanish) is to spend time practicing dialogue in a Spanish speaking environment or situation. When a student or individual trying to learn a language is immersed in a specific environment, the student or person is more likely to be confronted with various practical speaking situations. Furthermore, associating the new communication with actual situations aids tremendously with a student's ability to recall portions of newly learned dialogue and apply them correctly and naturally in a future encounter.

If a student cannot experience such a new environment, an alternative is to bring the new environment to the student. Environments may be duplicated in the form of toy systems that include play pieces that simulate various aspects of the chosen environment. Environments in which a student may desire to practice dialog may include, for example, an airport, a bank, a museum, a supermarket or any other common environment. In one implementation, toy system play pieces may, for example, simulate the environment of a typical supermarket from a particular geographic area. Using the system play pieces, the student can role play to engage in a simulated dialogue associated with purchasing food items from a that local supermarket in the particular geographic area. Similarly, as mentioned above, system play pieces could also simulate an airport or a museum to facilitate a dialogue or learn terms in another language which could aid the student in possible future encounters in such environments.

There is therefore a need to develop a toy system including play pieces that simulate an environment which facilitates a student's role playing to encourage practice of a foreign language dialogue in such environmental situations. Furthermore, there is a need for a toy system that enables a student to practice dialogue from a desired environment, without having to relocate to the actual environment to encounter the appropriate situations.

### SUMMARY OF THE INVENTION

Generally, the present specification discloses a system for teaching multiple language words or phrases associated with a specific environmental situation. The system includes a housing or base unit stylized in a real-life environmental theme (e.g., a supermarket) where people would commonly engage in conversation. The system also includes a variety of accessories associated with the environmental theme and stylized as real-life items (e.g., groceries) that might be the subject of a conversation under the theme. The accessories in the environment can be items that are used to learn words and/or phrases in multiple languages. The housing can include an identifier, a controller, a memory, an output device and a mode switch. The identifier is capable of identifying an accessory that is engaged with the identifier.

In one method of identification, the identifier can include several switches and each accessory can include several projections arranged in a pattern. Each accessory can have a unique pattern of projections so that when the accessory is associated with or placed in proximity to the identifier, a unique combination of the identifier's switches are activated to generate a unique set of identity information and identify the accessory. Specifically, the controller receives this unique identity information from the identifier and retrieves data from the memory that corresponds to the received identity information. The controller then signals the output device to generate an output, such as to audibly announce the word phrase from the selected data. The housing can also include a mode switch for switching between various electronic modes. When the system includes a mode switch, data in the memory is arranged in data sets. Switching modes signals the controller to retrieve data, such as word response data, from a particular data set associated with the activated mode and can therefore signal the production of different mode specific word phrase output or sound output based on the same input.

### BRIEF DESCRIPTION OF THE DRAWINGS

FIG. 1 illustrates a schematic illustration of an embodiment of a language teaching toy system of the present invention.

FIG. 2 illustrates a perspective view of an embodiment of a housing and accessories of a language teaching toy system of the present invention.

FIG. 3 illustrates a front view of an upper portion of the housing of the language teaching toy system of FIG. 2.

FIG. 4 illustrates a front view of a lower portion of the housing of the language teaching system of FIG. 2.

FIG. 5 illustrates a perspective view of the housing of the language teaching toy system of FIG. 2 showing the lower portion of the base being collapsed relative to the upper portion of the housing.

FIG. 6 illustrates a side perspective view of the housing of the language teaching toy system of FIG. 2 with the lower portion fully folded relative to the upper portion.

FIG. 7 illustrates an enlarged perspective view of a portion of the language teaching toy system of FIG. 2.

FIG. 8 illustrates an enlarged perspective view of an activity area on the lower portion of the housing of the language teaching toy system of FIG. 2.

FIG. 9 illustrates a close-up view of a sensor of the activity area of FIG. 8.

FIG. 10 illustrates top perspective views of several embodiments of the accessories of the language teaching toy system of the present invention.

FIG. 11 illustrates lower perspective views of the accessories of FIG. 10.

FIG. 12 illustrates a close-up view of two accessories of FIG. 10 showing each accessory's unique pattern of projections.

FIG. 13 illustrates a close-up view of projections of an accessory and a sensor of the language teaching toy system of FIG. 2.

FIG. 14 illustrates a close-up view of the activity area of the language learning toy system of FIG. 2.

Like reference numerals have been used to identify like elements throughout this disclosure.

### DETAILED DESCRIPTION OF THE INVENTION

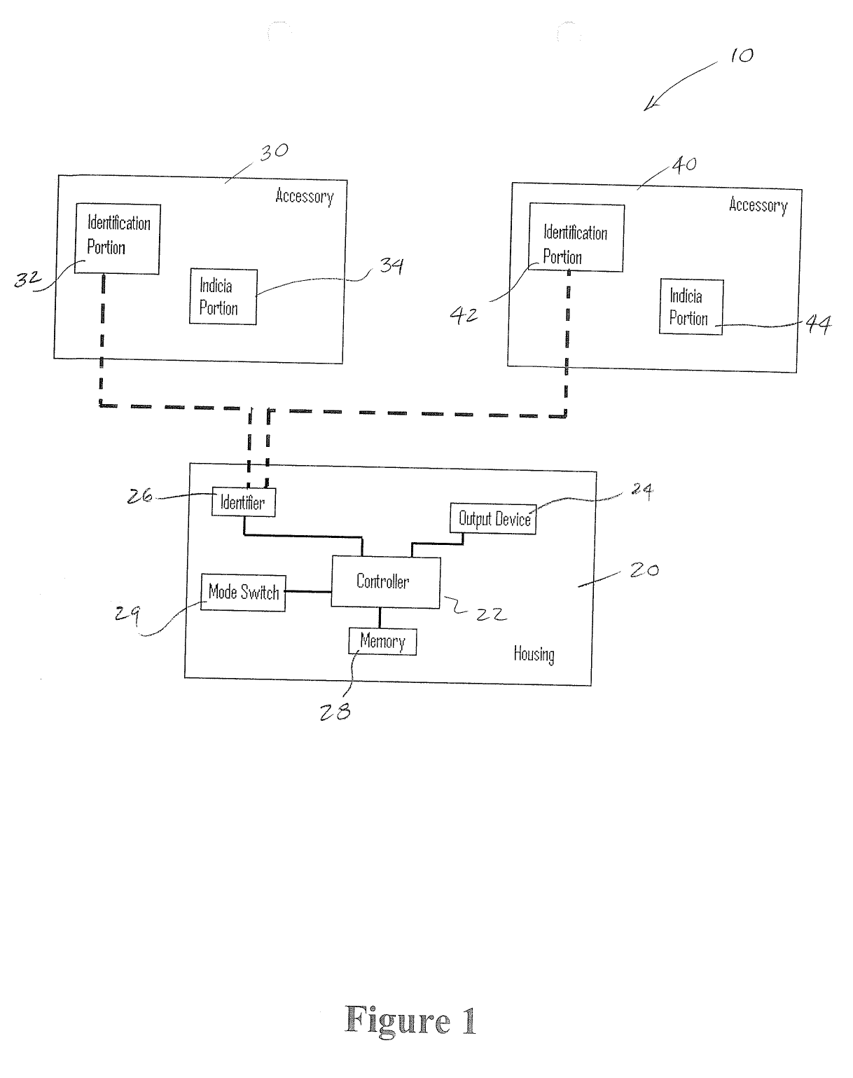

In accordance with the present invention, a language teaching toy system 10 is disclosed. FIG. 1 illustrates a schematic of an embodiment of a language teaching toy system 10 of the present invention.

The toy system 10 includes a housing 20 and several accessories 30 and 40 that are uniquely identifiable by the housing 20. To identify accessories 30, 40, the housing 20 contains a controller 22 for generally controlling the electronics of the system 10. Specifically, the housing 20 contains an identifier 26 for identifying an accessory 30, 40. The housing 20 also contains a memory 28 at least for storing word and sound data. Furthermore, an output device in the housing 20 can be used to generate an output, such as an audible word or sound represented by the word or sound data stored in the memory 28.

Each accessory 30, 40 includes an identity or identification portion 32, 42 and an indicia portion 34, 44. The indicia portions 34, 44 enable a user to visually identify an accessory and to distinguish it from other accessories. Correspondingly, the identity portion 32, 42 of each accessory enables the identifier 26 to uniquely identify each accessory of the toy system 10. Therefore, the toy system 10 can audibly announce what it has identified electronically and the user can compare that announcement with what the user has identified visually.

In use, a user visually identifies an accessory by its indicia or indicia portion 34, 44, chooses an accessory and associates (such as moving the accessory in proximity to the identifier) the accessory with the identifier 26. The controller 22 then identifies the accessory through the identifier 26. Based on the identity of the identified accessory, the controller 22 retrieves sound or word data from the memory 28 and transmits the sound or word data to the output device 24. The output device 24 then converts the sound or word data into an electronic signal and plays a sound or word (represented by the data) on a speaker.

Identification of an accessory using the identifier 26 of the toy system 10 can be accomplished in a number of ways. Identification merely requires communication between the identifier 26 and the accessory. In one embodiment, communication between the identifier 26 and an accessory can be achieved using projections or protrusions on one of the identifier 26 and the accessory and several switches on the other of the identifier 26 and the accessory. In that embodiment, the projections or protrusions are engaged with the switches and as a result, the particular accessory can be identified. In other embodiments, the communication can by achieved by light, magnetic attraction, or a wireless signal. For example, the identifier 26 can be an optical scanner and the identity or identification portion 32 on the accessory 30 can be an optical identifier such as a bar code or other indicia that can be read or identified by the optical scanner. The particular communication items used in these alternative embodiments can be conventional elements or components.

In this embodiment, the housing 20 also includes a mode switch 29 for changing the mode of operation of the controller 22. If the toy system 10 includes a mode switch 29 that switches the controller 22 between multiple modes of operation, different types of data can be stored in data sets. For example, different sound and word data can be stored in the memory 28 in different data sets that are accessed by the electronic system depending on the mode of operation of the system 10. Switching between modes causes the controller 22 to retrieve data from a data set associated with a specific mode. Therefore, one input, such as the identification of a unique accessory, results in a first output if the controller 22 is in a first mode or a second output if the controller 22 is in a second mode.

In one embodiment, the toy system 10 can generate audible output that includes words or phrases in multiple languages. For example, when accessory 30 is in communication with the identifier 26, the name of the accessory 30 can be output via the output device 24 in one or more languages. Thus, a child can learn a word or words in multiple languages by playing with an item and using the toy system 10 to generate an output. In some embodiments, the words can relate to objects that are familiar to children. For example, the objects can include everyday items such as milk, cereal, flowers, and/cakes. Alternatively, the words can relate to numbers, colors, shapes, and social skills, such as saying hello, please, and thank you. The system generates output in at least two different languages, with one of the languages being the native language to the country in which the toy system is distributed or sold. For example, when the toy system is distributed or sold in the United States, the toy system can generate outputs in English (the native language of the United States) and in at least one other language, such as Spanish. In that example, the system can generate outputs in English and in Spanish for each of the items used with the identifier. First, the English word or words are output and then the Spanish translation of the word or words is output. Outputs in any other languages, such as French, German, Italian, Japanese as well as other languages, can be utilized with the toy system. The at least two different languages can be selected by the manufacturer and provided with the toy system. If several languages are provided with the toy system, the end user has the ability to select at least two of the languages using an input device, such as a switch. For simplicity reasons only, English and Spanish are the two different languages referenced below with respect to the toy system. An exemplary embodiment of a toy system and methods of using the toy system are described in detail below.

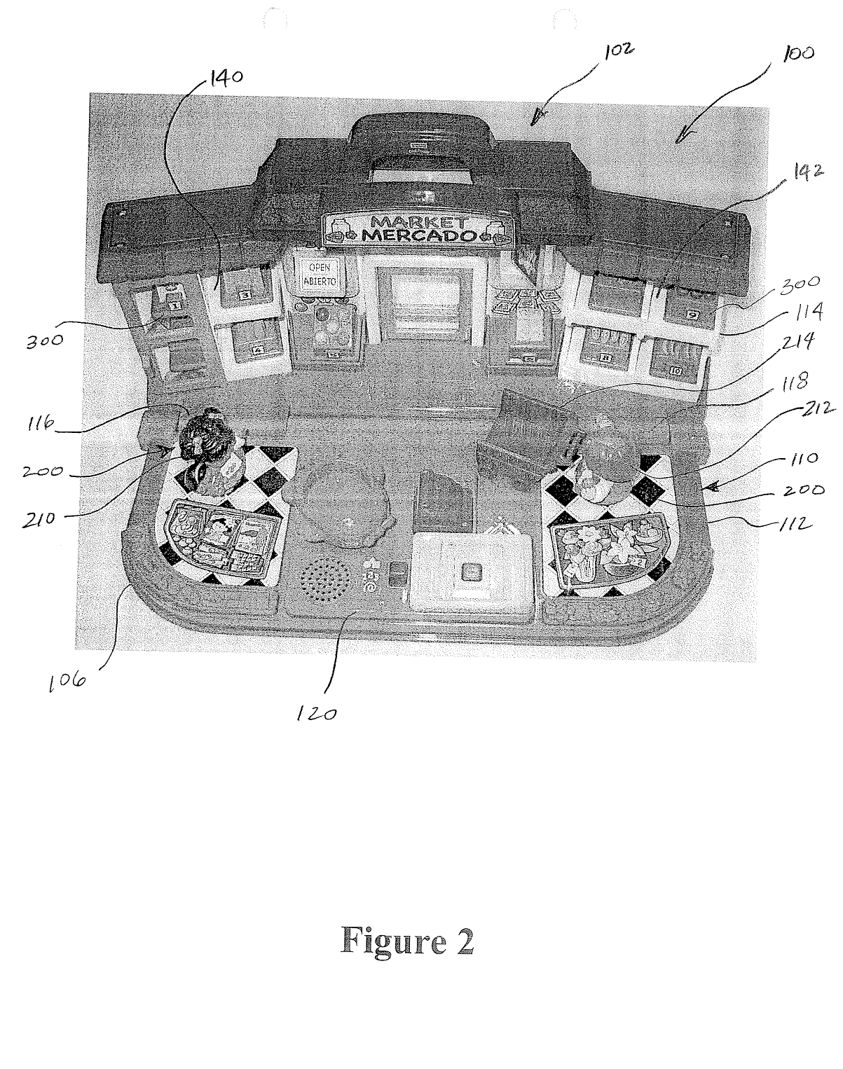

An embodiment of a language learning toy system according to the invention is illustrated in FIG. 2. In this embodiment, the language learning toy system 100 includes a housing 106 and several accessories 200. FIG. 2 illustrates a perspective view of the housing 106 of the language teaching toy system 100 in an extended or deployed configuration 102. The language teaching toy system 100 is an example of the above-described toy system 10 configured to resemble a toy version of a supermarket. The language teaching toy system 100 has a base 110 configured or stylized as a supermarket structure. The base 110 includes a lower portion 112 and an upper portion 114. The lower portion 112 is pivotally connected to the upper portion 114 by hinges or couplers 116, 118 spaced apart and disposed on one side of base 110.

The lower portion 112 of the base 110 also includes an activity area 120. In FIG. 2, the activity area 120 is configured or stylized as a supermarket check-out area. The activity area 120 includes several sensors for facilitating interactive play and learning. The sensors and interactive play features are discussed in detail below. The base 110 includes a shelf or storage areas 140, 142 which can receive and store various accessories 300. The shelf or storage areas 140, 142 are also discussed in greater detail below. To add to the role play experience, the supermarket themed base 110 includes accessory figures 200 in the form of shoppers 210, 212 that can pretend to utilize a shopping cart 214 as they peruse storage areas 140, 142. Storage areas 140, 142 can receive accessories 300 therein and the accessories 300 can be retrieved from the storage areas by shoppers 210, 212 in a play manner simulating shopping.

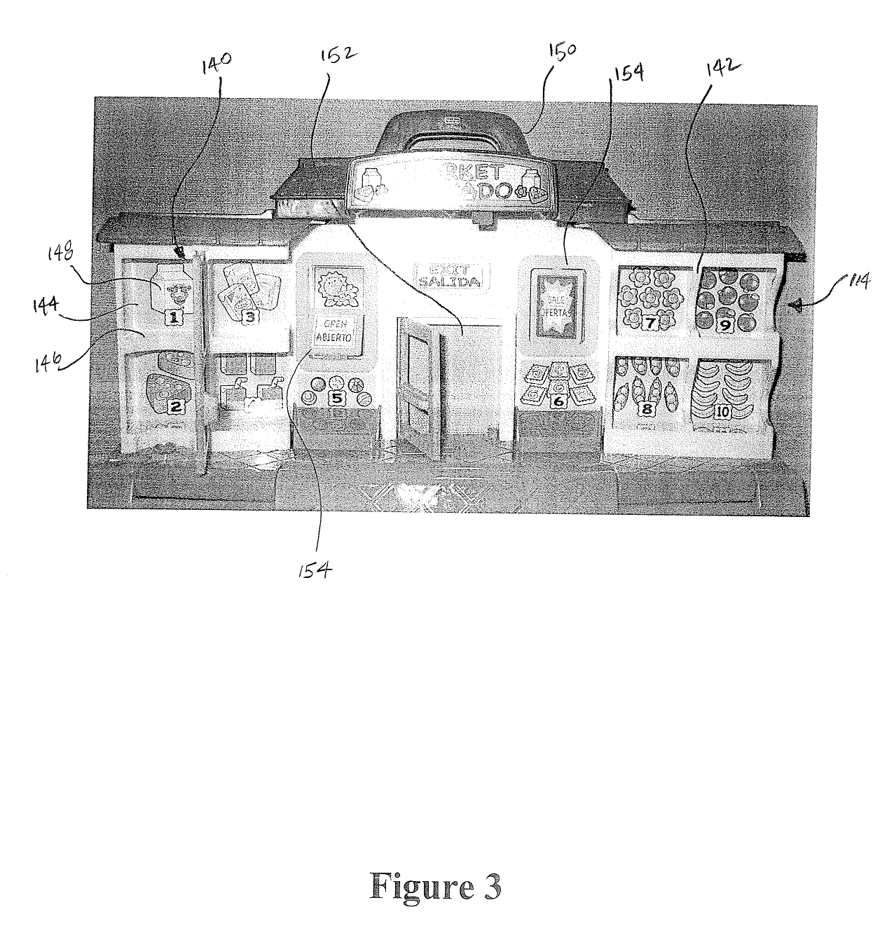

FIG. 3 illustrates a front view of the upper portion 114 of the base 110 of the language teaching toy system 100 of FIG. 2. As previously described, the upper portion 114 includes storage areas 140, 142, each of which includes several receptacles 144 that are configured or sized to receive one or more accessories 300, Each receptacle 144 also includes a shelf 146 for receiving an accessory 300 thereon. Furthermore, each receptacle 144 includes indicia 148 that is related to or corresponding to the indicia on each accessory 300 (the accessory indicia is described below). A user can match the indicia 148 with the indicia on an accessory 300 to place the accessory 300 in its corresponding receptacle 144.

FIG. 3 also shows a handle 150 that is attached to the upper portion 144 of base 110 for transporting the language teaching toy system 100. The upper portion 144 includes a store entrance 151 for the shoppers 210, 212 and pivotally mounted signs 154 on the wall of the upper portion 114 to, for example, announce a store sale or to announce whether the store is open or closed. The different indicia 148 associated with the receptacles 144 are illustrated in FIG. 3.

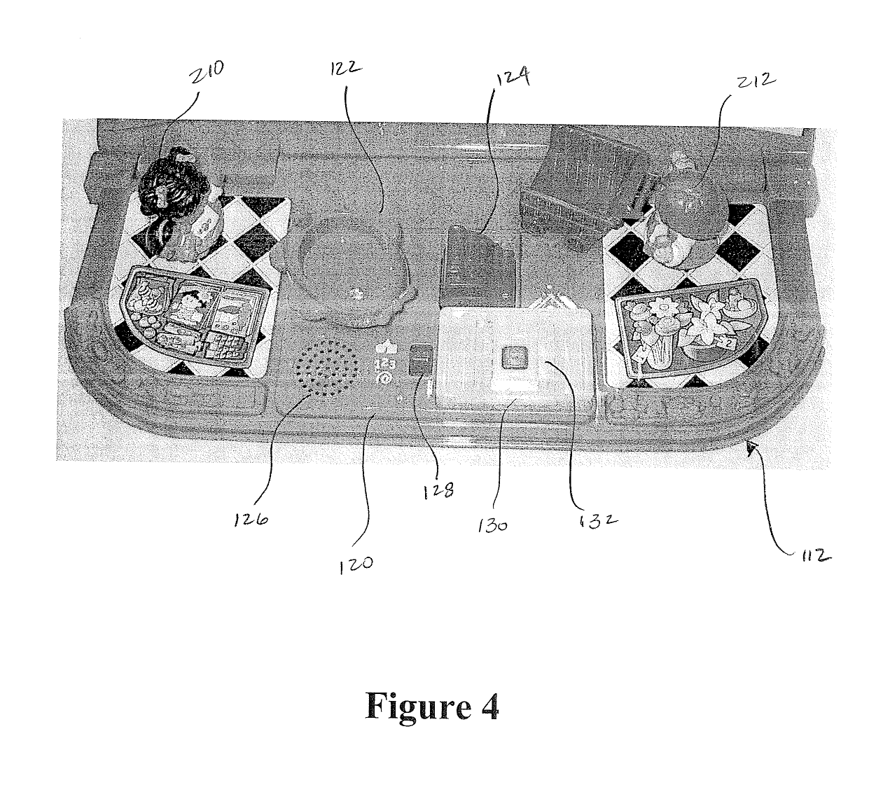

FIG. 4 illustrates the lower portion 112 of the housing 106 of the language teaching toy system 100. As discussed above, the lower portion 112 includes an activity area 120. The activity area 120 includes an interactive coin ride 121, a toy cash register 124 and an output generating device, such as a speaker 129. The activity area 120 also includes a mode switch 128 and an identifier or sensor 130 that has an engagement area 132. The engagement area 132 can be referred to as an accessory receiving area. In this embodiment, there are three indicia designations next to the mode switch 128 to designate three electronic modes in which the language teaching toy system 100 can operate. The three modes include an English/Spanish speaking mode, a counting mode, and a play mode. When the system is in the counting mode, associating the accessory with the number 2 on it with the identifier will result in the output of “two” and “dos.” By associating the same accessory a second time, an output of “uno” and “dos” is generated. When the accessory with the number 5 is associated with the identifier, the first touch will result in an output of “five” and “cinco.” A second touch of that accessory will result in “uno, dos, tres, cuatro, cinco.”

The coin ride 121 is a movably mounted component that is in communication with a switch, which when activated by the movement of the coin ride 121, generates output through the speaker 126. The cash register 124 is movably mounted to the base 110 and coupled to a switch that is activated when the cash register 124 is moved. Particular outputs are generated by the toy system 110 when that switch is activated.

The activity area 120 includes a controller corresponding to the controller 22 of the toy system 10 described above. The activity area 120 allows a user to interact with the language teaching toy system 100 by providing a number of inputs to the electronic controller (e.g., buttons that can be pressed) and by receiving a number of outputs (e.g., lights and/or sounds) from the controller. These features will be described in more detail below.

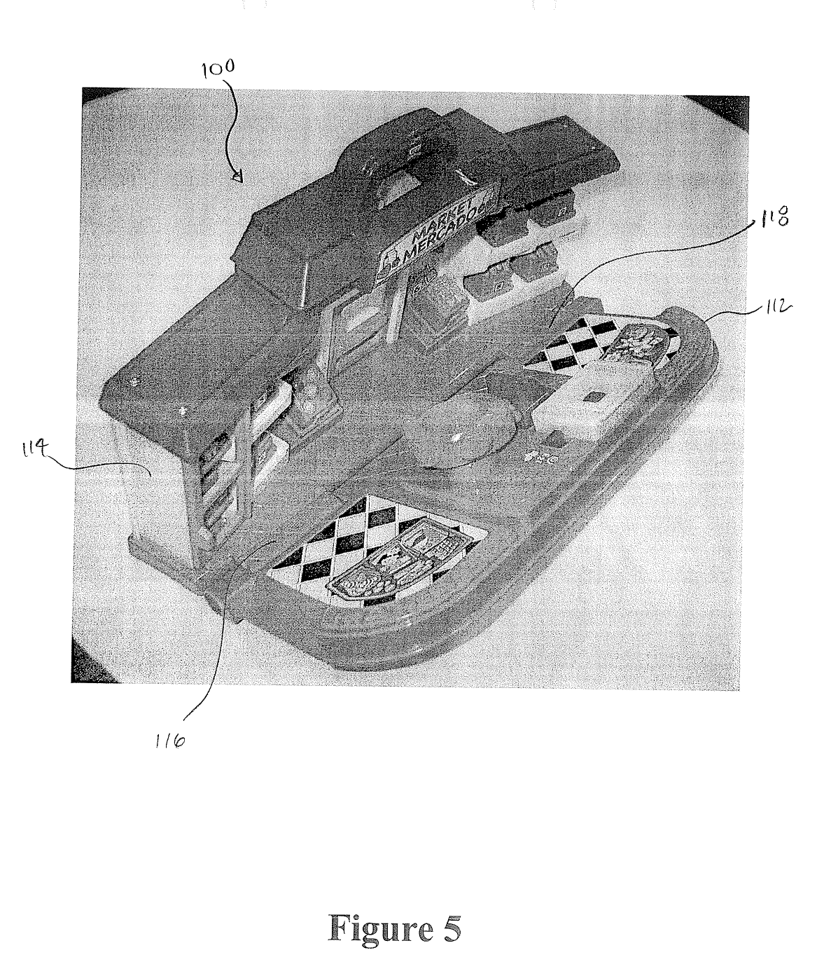

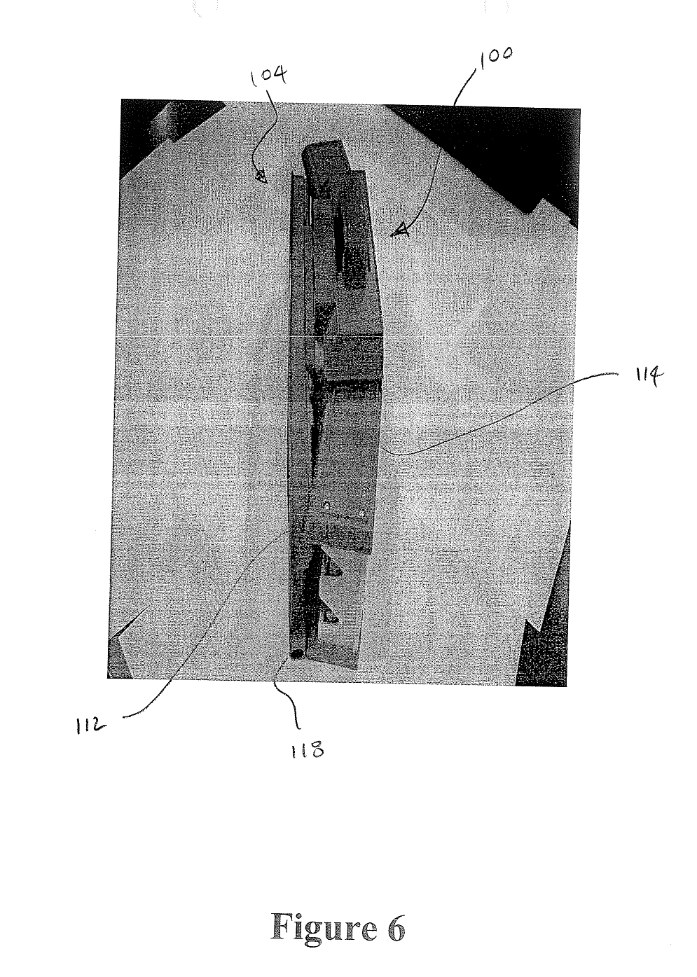

In this embodiment, the housing 106 of the toy system 100 can be selectively disposed in multiple configurations. As illustrated FIG. 2, the housing 106 can be disposed in a deployed configuration. Referring to FIG. 5, the lower portion 112 is illustrated as being collapsed or moving upwardly relative to the upper portion 114. As discussed above, the lower portion 112 and upper portion 114 of base 110 are connected by couplers 116 and 118 which allow the lower portion 112 to pivot upwardly relative to the upper portion 114 into a compact, carrying position. FIG. 6 illustrates a side perspective view of the housing 106 of the language teaching toy system 100 with the lower portion 112 fully folded relative to the upper portion 114 into the collapsed or folded configuration 104.

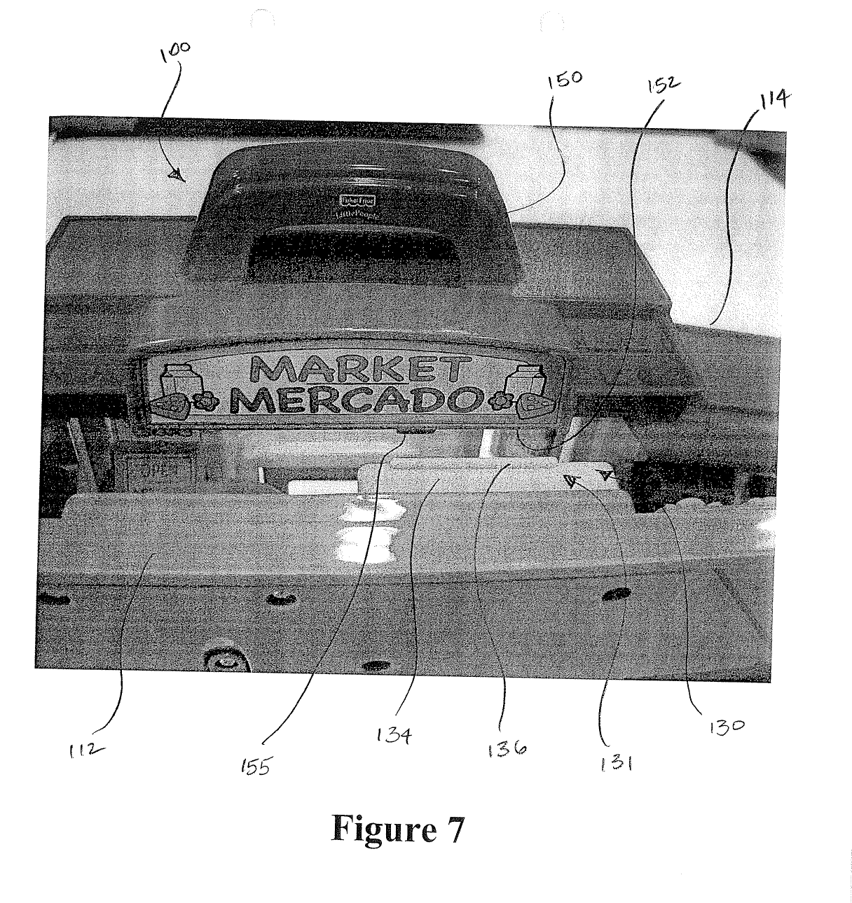

FIG. 7 illustrates the language teaching toy system 100 showing a latch or lock mechanism 131 for securing the base 110 in the folded configuration 104 shown in FIG. 6. Specifically, FIG. 7 shows the lower portion 112 of base 110 almost latched to the upper portion 114. The latch or lock mechanism 131 includes a tab 136 extending upwardly from a wall 134 on the side of the identifier 130. The upper portion 114 includes a ledge 152 from which a biased latch 155 extends downwardly. As the lower portion 112 closes, the tab 136 approaches the latch and the latch 155 snaps over the tab 136, preventing the lower portion 112 from pivoting relative to the upper portion 114 about couplers 116, 118. The upper portion 114 and the lower portion 112 are now locked in the folded configuration 104. The upper portion 114 and the lower portion 112 can be separated by pulling the lower portion 112 with respect to upper portion 114 with a sufficient force to overcome the force of the latch 155.

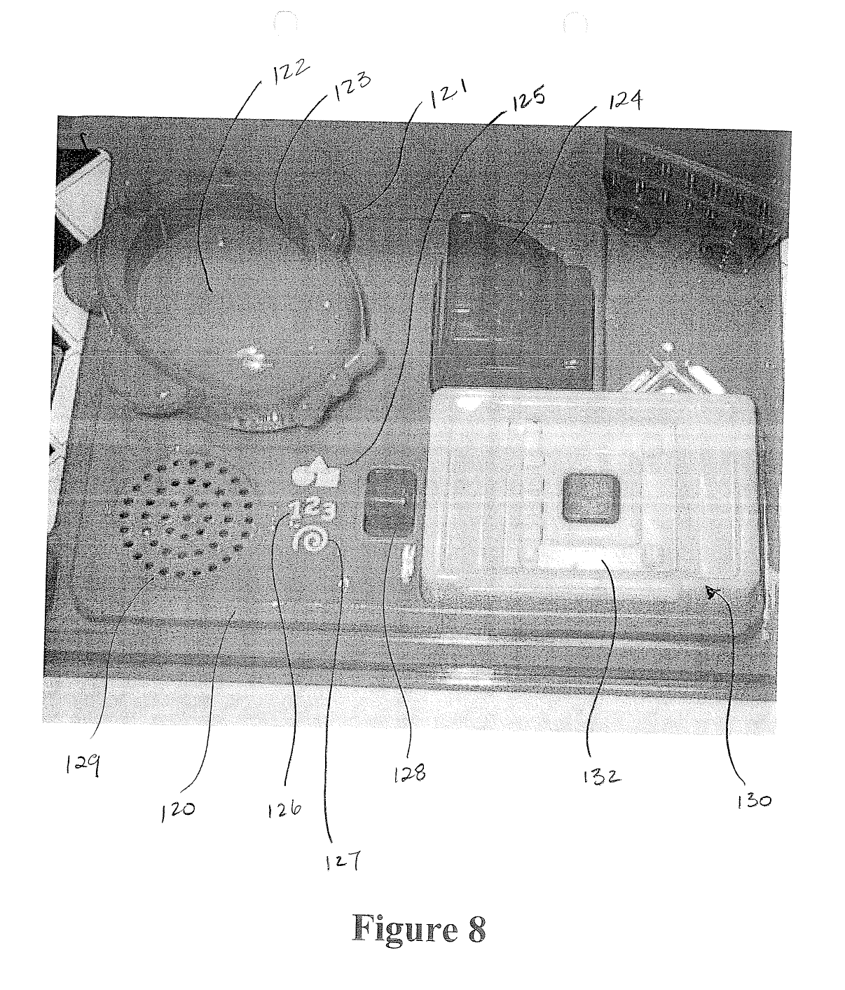

Referring to FIG. 8, the activity area 120 on the lower portion 112 of the base 110 is illustrated. As discussed above, the activity area 120 includes an interactive coin ride 121, a cash register 124, a speaker 126, a mode switch 128 and an identifier 130 having an engagement area 132.

As previously mentioned, the activity area 120 includes an electronic controller. The electronic controller interactively receives information from several sensors, including a first sensor 121 (the coin ride), a second sensor 124 (the cash register) and a third sensor 130 (also referred to above as an identifier).

The first sensor 121 has a seat and a switch (not shown) that is activated by pressing the seat which is stylized as a children's coin ride toy (commonly located near supermarket checkout areas). The coin ride toy seat includes a receptacle 122 defined by a wall 123. Therefore, when shopper 210 or 212 is placed in the receptacle 122 and the seat is pressed, the switch is activated to send a signal to the controller. The controller receives the signal, retrieves data from a memory, and sends a signal to an output device (e.g., a speaker 129) to output an audible sound or message.

The activity area 120 also includes a second sensor 124 that includes a switch (not shown) and that is actuated by pressing a button stylized as a cash register. Pressing the cash register button sends a signal to the controller to retrieve specific data from the memory. The controller then sends a signal to an output device (e.g., a speaker) to generate a particular output, such as an audible word or message. Pressing the cash register button a second time generates a second output different from the first output. Furthermore, each output message is related to a message that might normally be heard when checking out at a grocery check-out counter. In one embodiment, the message may first be announced in a first language (e.g., English) immediately followed by the same message announced in a second language (e.g., Spanish). As a result, the language learning toy system 100 associates a first language with a second language to teach the second language. Furthermore, the system 100 reinforces the second language in a real-life role play situational context (e.g., a grocery store checkout environment).

Moreover, the activity area 120 includes another sensor or identifier 130 that is configured or stylized as a supermarket checkout counter. The sensor 130 includes an engagement area 132 with several switches that may be depressed or engaged by accessories 300. The sensor 130 is configured to identify the particular accessory with which it is engaged.

As discussed above the language teaching toy system 100 of the present invention also includes a mode switch 29 for switching the controller between activity modes. Three visual indicia representations 125, 126, and 127 are located along side the mode switch 128 in respective positions that correspond to the three mode positions of the mode switch 128.

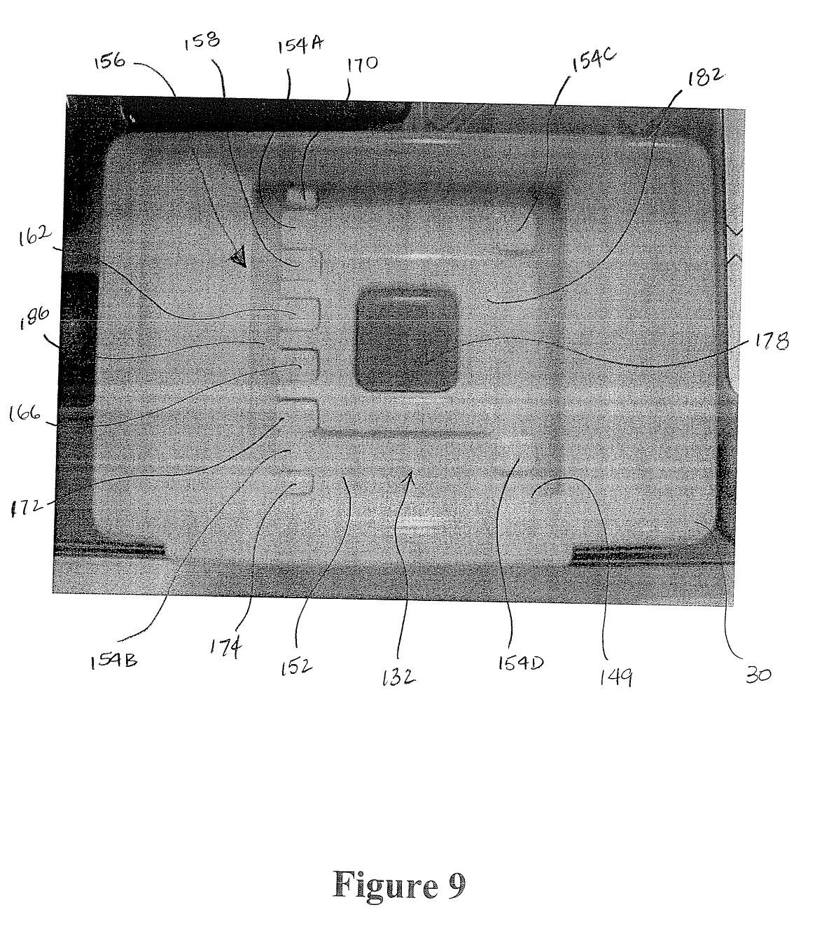

FIG. 9 illustrates a close-up view of the sensor 130. Sensor 130 includes an engaging area 132. The engaging area 132 has a receiving perimeter 149 within which an accessory 300 is received on a receiving surface 157. The engaging area 132 includes several posts 154A-D that are spaced apart. In this embodiment, the posts 154A-D are arranged to be at four corners around the engaging area 132. While the receiving perimeter 149 positions an accessory 300 along the outside of the accessory 300, the posts 154A-D are disposed and configured to position the accessory 300 along the inside of the accessory 300.

The engagement area 132 also includes an identity switch array 156 having a first identity switch 158, a second identity switch 162, a third identity switch 166 and a fourth identity switch 172 for identifying which specific accessory 300 has been placed in the engagement area. In other embodiments of the toy system, any number of identity switches can be provided in the array.

The engagement area 132 also includes a first presence switch 170 and a second presence switch 174 for detecting the presence of an accessory 300 in the engagement area 132. In this embodiment, the presence switches 170, 174 are depressed along with the appropriate switch array switches in order to get an output. Also located in the engagement area 132 is button 178, which each time it is pressed, causes an output of a different word and/or phrase in a first language and then in a second language (e.g., Spanish and English). This feature allows a user to practice foreign language words and phrases in a repetitive manner.

The button 178 is large enough to be accessed with a finger. Accordingly, the system can generate an output when the button 178 is pressed without the need of an insertion of an accessory. This manner of operation allows a user to practice dialogue in different languages by simply pressing button 178 repeatedly.

FIG. 9 also shows a switch support 182 that surrounds the button 178 and includes several extensions that are disposed between the switches in the array 156 to reduce the possibility of an unintentional pressing or engaging of any of the switches 158, 162, 166, 172 or button 178 while placing an accessory 300 in the engagement area 132. The engagement area 132 also includes a channel or trench 186 within which a portion of the accessory 300 is received.

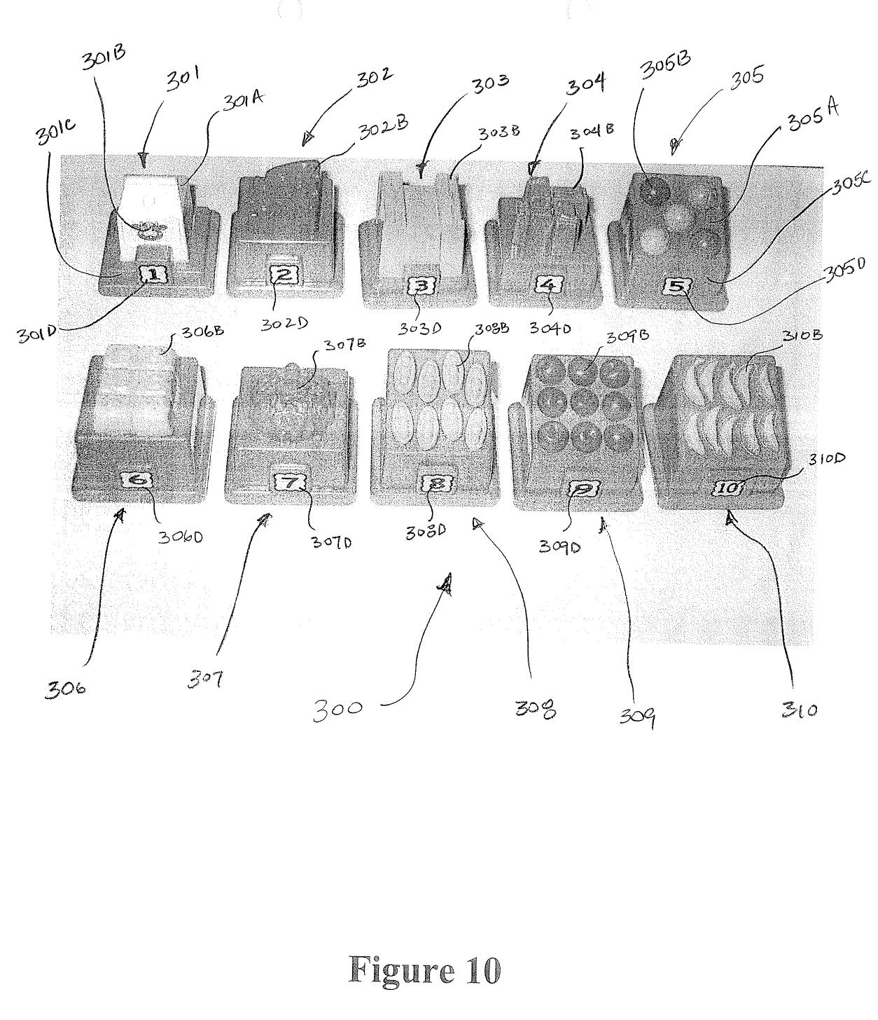

The language teaching toy system includes several accessories 300 that can be formed in different embodiments. Referring to FIG. 10, ten different embodiments of an accessory 300 are illustrated. Each accessory 300 includes an upper or top portion that is different from the upper portions of the other accessories. FIG. 10 illustrates several embodiments of the accessories 300 of the language teaching toy system. As shown, each accessory 301-310 is configured or stylized (both through color and shape) to resemble a real-life item. Each accessory 301-310 also includes a top portion having top indicia and at least one side wall that has side indicia.

As an example, first accessory 301 includes top portion 301A with top indicia 301B which is configured to resemble a carton of milk, a sidewall 301C with side indicia 301D thereon labeled as the number one (“1”). The second accessory 302 includes a top portion with indicia 302B which is configured to resemble a piece of cheese and a sidewall with side indicia 302D thereon labeled as the number two (“2”). Third accessory 303 includes a top portion with top indicia 303B which is configured to resemble cereal and a sidewall with side indicia 303D thereon labeled as the number three (“3”). Fourth accessory 304 includes a top portion with top indicia 304B which is configured to resemble juice and a sidewall with side indicia 304D thereon labeled as the number four (“4”). Fifth accessory 305 includes a top portion with top indicia 305B which is configured to resemble portions of balls and a sidewall with side indicia 305D thereon labeled as the number five (“5”). Sixth accessory 306 includes a top portion with top indicia 307B which is configured to resemble cakes and a sidewall with side indicia 306D thereon labeled as the number six (“6”). Seventh accessory 307 includes a top portion with top indicia 307B which is configured to resemble flowers and a sidewall with side indicia 307D thereon labeled as the number seven (“7”). Eighth accessory 308 includes a top portion with top indicia 308B which is configured to resemble peas and a sidewall with side indicia 308D thereon labeled as the number eight (“8”). Ninth accessory 309 includes a top portion with top indicia 309B which is configured to resemble apples and a sidewall with side indicia 309D thereon labeled as the number nine (“9”). Tenth accessory 310 includes a top portion with top indicia 310B which is configured to resemble bananas and a sidewall with side indicia 310D thereon labeled as the number ten (“10”).

In addition to numbers, the indicia of the accessories 301-310 can be any type of visual indicia, including words and colors. For example, the words may be associated with the items on the accessory or the quantity of items on the accessory. Alternatively, a color, in any shape or size, may be provided on a portion of an accessory. In other embodiments, the particular shape of the accessories 301-310 can vary. Also, the quantity of indicia on an accessory can vary. For example, accessories can be used with indicia only on one side. Moreover, in other embodiments, the particular indicia used for an accessory can be any type of indicia, including words, colors, different shapes and themes. Finally, the locations of the indicia on the accessories in different embodiments of the invention can vary.

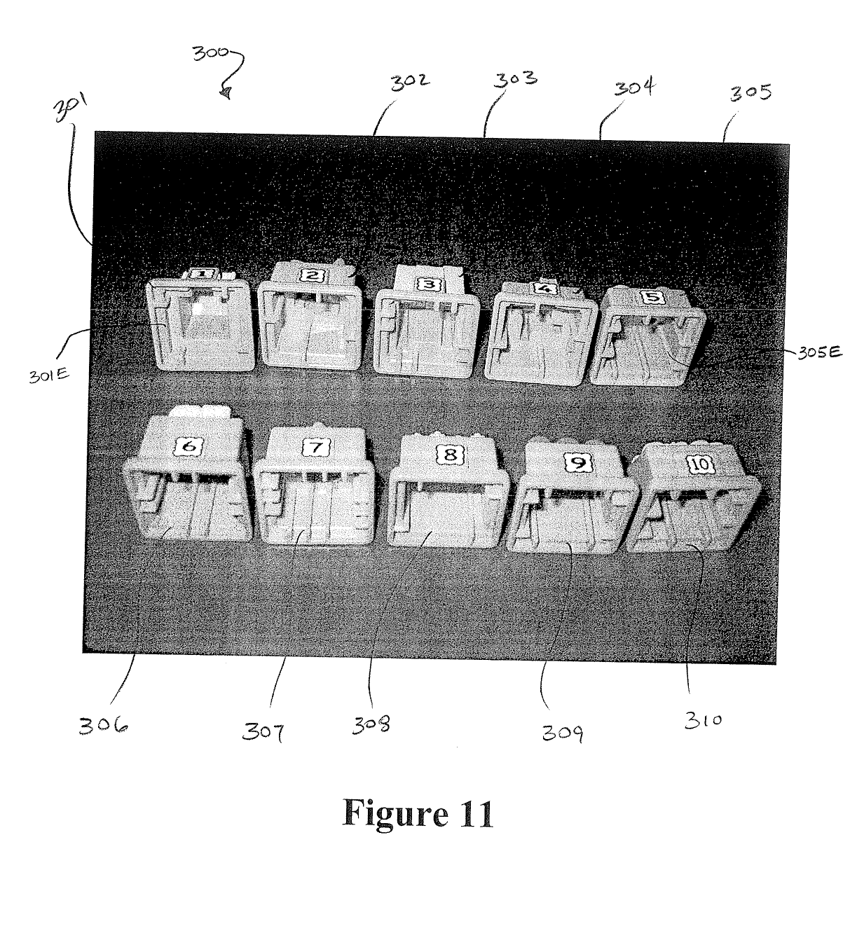

FIG. 11 illustrates a bottom portion of each of the accessories 301-310 showing an opening in the bottom portion. As illustrated, each of the accessories 301-310 has a lower portion that is different from the lower portions of the other accessories 301-310. As will be described in detail below, the distinct lower portions of the accessories 301-310 are used to distinguish the particular accessories 301-310.

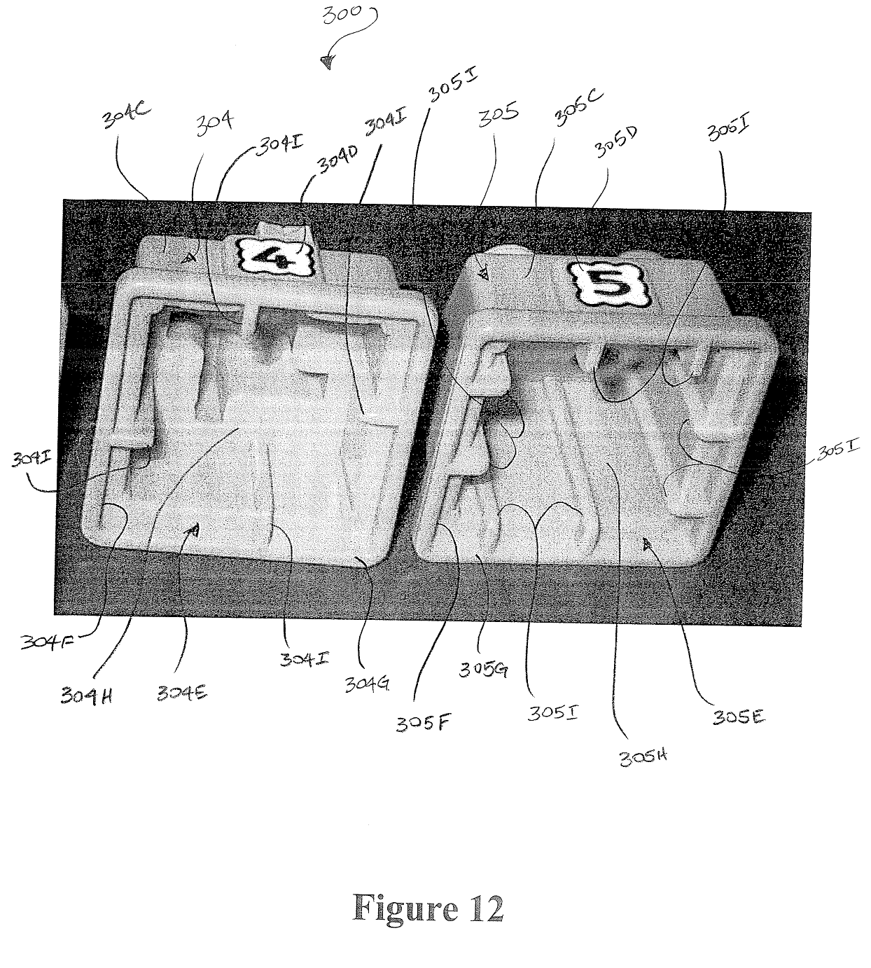

Referring to FIG. 12, accessories 304 and 305 are illustrated. FIG. 12 illustrates a close-up view of accessories 304 and 305, which include openings 304E and 305E, respectively. Each accessory 304, 305 has a bottom portion 304E, 305E, openings 304F, 305F, a perimeter 304G, 305G, a cavity 304H, 305H, and an identity portion 304I, 305I arranged as symmetric projections about a center line through the accessory 300. The identity portions 304I, 305I are unique structures of projections on each side of the bottom portions 304E, 305E. Specifically, FIG. 12 shows the identity portions 304I, 305I being formed on each of the four sides of the bottom portions of accessories 304, 305. As illustrated, the identity portion 304I of accessory 304 includes a single projection formed at the same location on each of the four sides. The identity portion 305I of accessory 305 includes two spaced-apart projections formed at the same locations on each of the four sides. The identity portions of the other accessories 301-303 and 306-310 comprise different combinations of projections, whether by quantity or by spacing.

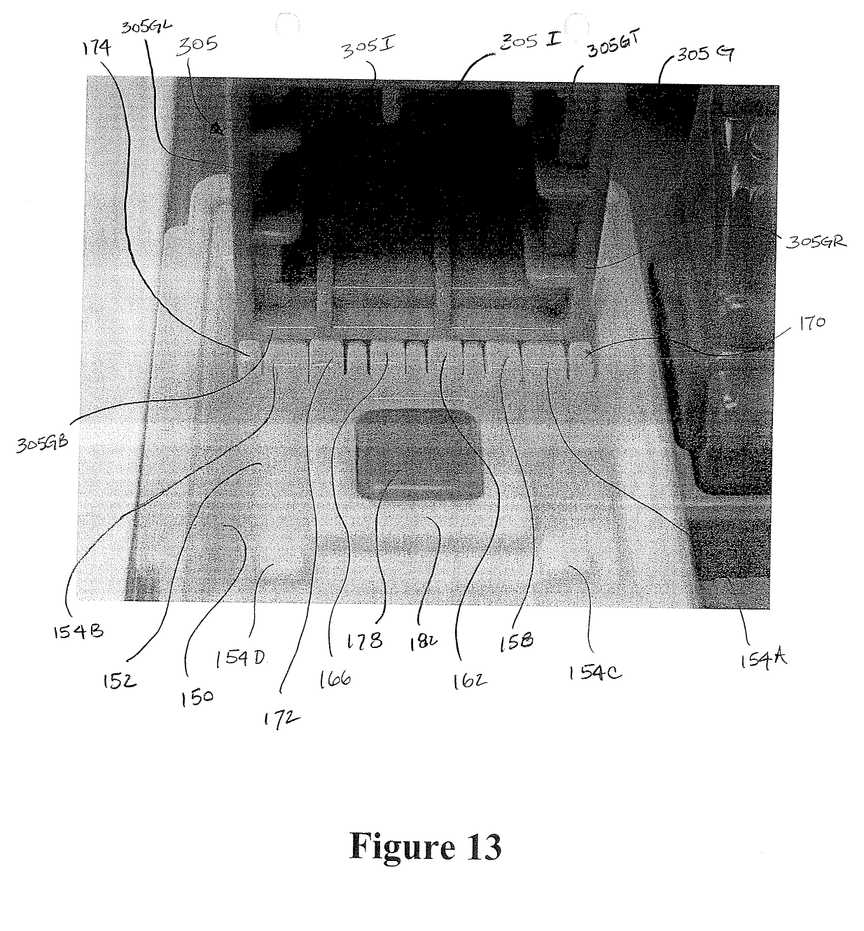

FIG. 13 illustrates a close-up view of accessory 305 turned onto one side and showing the projections of identity portion 305I being associated or aligned with switches 162 and 172 of sensor or identifier 130. Also shown in FIG. 13, the accessory 305 has a four sided perimeter that includes a bottom 305GB, a top 305GT, a left side 305GL and a right side 305GR. In operation, the four perimeter sides 305GB, 305GT, 305GL, 305GR of accessory 305 are aligned and engaged with the receiving perimeter 149 outside of posts 154A-D and onto the receiving surface 157 of engaging area 132 (see FIGS. 9 and 13). When the bottom 305GB is received in the channel or trench 186, the projections of the identity portion 305I contact switches 162, 172, the left side 305GL contacts presence switch 174 and the right side 305GR contacts presence switch 170. When the presence switches 170 and 172 are contacted and engaged, the control system determines that a valid accessory is present. As discussed and shown in FIG. 11, each accessory 300 includes a unique pattern of projections in its identity portion 301I-310I. Therefore, each accessory's projection pattern aligns with and depresses a unique combination of switches 158, 162, 166, and 172.

In other words, the bottom portion of each accessory 301-310 has four sides and each side has the same repeated identity portion structured as a pattern of projections. Because each side has the same pattern of projections that are identical with respect to its respective side and symmetric with respect to the accessory's center, the accessories 301-310 can be received in the engaging area 132 in any facing orientation. Thus, if the accessory is rotated 90°, 180° or 270° in the engaging area 132, its projections will still engage the same switches. The result of this identical, symmetrical arrangement is that no matter which side 305GB, 305GT, 305GL, 305GR of the perimeter 305G is positioned in the channel or trench 186 (best shown in FIG. 9), the projections of the corresponding identity portion 305I will align to engage the same switches. Consequently, an accessory 300 can then be identified in any orientation.

As briefly mentioned above, the general structure of the engagement area 132, which includes posts 154A-D, a perimeter 149 and a switch support 182, reduces the possibility of an unintentional pressing of any of switches 158, 162, 166, or 172 or button 178 while placing an accessory 300 in the engagement area 132.

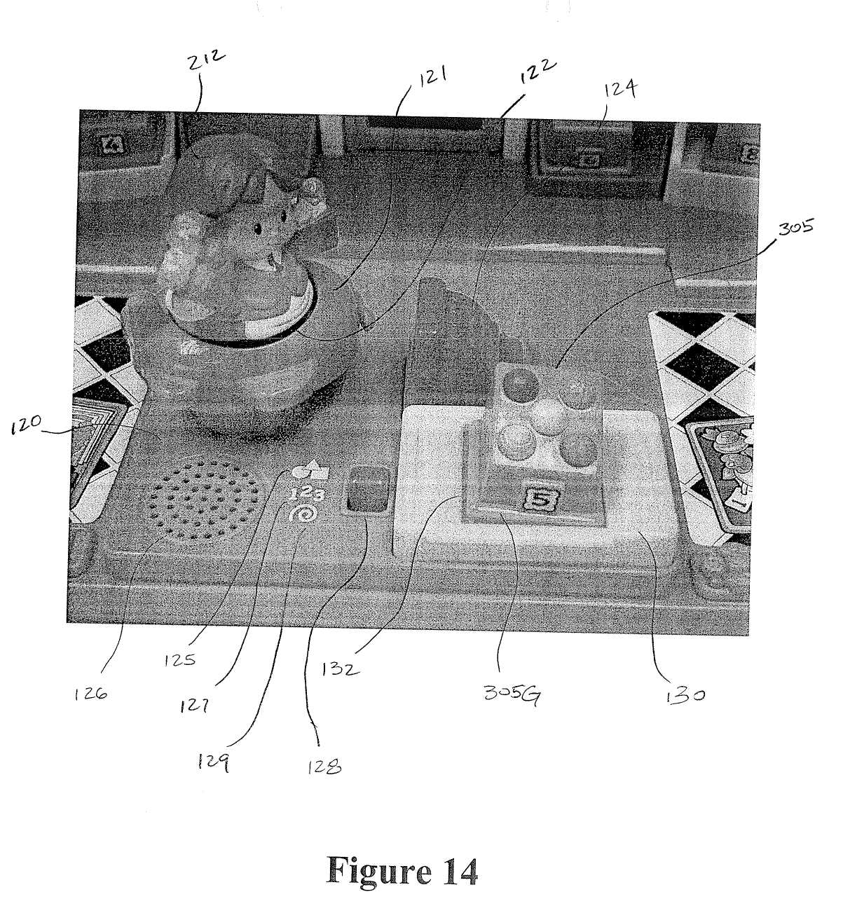

FIG. 14 illustrates the activity area 120 showing an accessory 305 positioned proximate to sensor or identifier 130 of FIG. 9. FIG. 14 also shows a FIG. 212 disposed in the receptacle 122 of the coin ride 121. The left side of the accessory 305 appears slightly elevated compared to its opposite side as the corresponding switches (switches 162 and 172 in the case of accessory 305) hold the left side slightly higher initially. When a user presses the top of the accessory 305, the corresponding switches are depressed and the elevated side of the perimeter 305G is received into the channel or trench 186. Also, when the user presses FIG. 212 downwardly, the coin ride 121 is depressed to close the switch of sensor 121 to signal the controller to direct output to be announced.

The above features of the language teaching toy system 100 facilitate effective learning of a new language. The base 110 of the language teaching toy system 100 is generally configured as an environment in which a user would likely have a conversation (e.g., a super market). In addition, the language teaching toy system 100 helps a user to get into the mindset of speaking in a specific environment. It encourages this mindset by providing environmentally specific and suggestive materials and props with which to role play and by providing an electronic interactive controller that receives situational user input (e.g., associating an accessory 300 with the identifier 130) and outputs related multi-lingual dialogue (e.g., sounds or words in multiple languages).

Specifically, an English speaking user can pretend to be engaged in a shopping experience (e.g., in a Spanish speaking environment). The user peruses the shelves to decide which items to purchase. The user can then place the items in a pretend shopping cart for transport to the checkout counter. The English speaking user can now practice typical dialogue with a Spanish/English speaking cashier. The first sensor 121, stylized as a coin operated ride is attached to a button, which when pressed, generates fun sounds or words. The sound and word output can be altered if the mode switch 128 is repositioned between modes. The second sensor 124 stylized as a cash register button generates phrases (in English and then in Spanish) a cashier might say. In a different mode, the phrases might be numbers repeated in sequence in English and then in Spanish.

The third sensor or identifier 130 is configured as a cash register counter for receiving items (accessories 300) chosen from the shelves 146 for purchase. The items for purchase (accessories 300) are brought to and place in the engaging area 132 of the counter to be scanned. The particular accessory 301-310 is then placed in the engaging area 132 on the counter where its identity portion 301I-310I depresses a unique combination of switches 158, 162, 166, 172 in the switch array 156. The electronic controller then receives signals from the switches 158, 162, 166, 172 to identify which grocery item (accessory 300) has been placed on the counter (engaging area 132). When the electronic controller determines which item has been placed on the counter, the controller can then retrieve data related to the identified item (accessory 300) and trigger an output response (e.g., sounds or words) in English then in Spanish.

As discussed above, an accessory 300 may include multiple indicia thereon. When the accessory 300 is identified, the controller can transmit an output relative to either or both indicia. For example, as discussed above, each accessory 300 has a first set of visual indicia that uniquely identifies it (e.g. cheese) and a second set of visual indicia indicating associated with a number (e.g., “2”). Because an accessory 300 may have multiple indicia, when mode switch 128 is switched between modes, the controller may switch between output words associated with the first item set (e.g., milk, cheese etc.) and output words associated with the second number set (e.g., “1,” “2” etc.). Therefore, in a first mode (e.g., for an accessory 302), the controller may output the phrase “cheese” and in a second mode the controller (for that same accessory 302) may output the word “two.” In one embodiment, the output can be related to the shape of the accessory.

In an alternative embodiment, an optical scanner can be used in lieu of the switch-based identifier discussed above. In that arrangement, an optical identifier, such as a bar code or a symbol, can be provided at one or more locations on the accessory as the identity portion in lieu of the projections. In another embodiment, indentations or recesses can be formed on the accessory as part of the identity portion. In that arrangement, the identifier can include a series of switches that engage the indentations or recesses of the accessory to identify the accessory.

Thus, it is intended that the present invention cover the modifications and variations of this invention that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration.

We claim:

1. A language teaching toy system comprising:
a base unit including an electronic control system configured to produce sensory stimulating output, the electronic control system including an identifier;
a plurality of toy accessories, each of the toy accessories including an identity portion, the identity portion of at least one of the accessories being different from the identity portion of another of the accessories, the identity portions being discernable by the identifier, the control system being operable to identify the toy accessories when the identity portion of an accessory is associated with the identifier; and
wherein upon identification of a particular toy accessory by the control system, the control system produces accessory-specific sensory stimulating output in at least two different languages.

2. The language teaching toy system of claim 1, wherein the identity portion of each of the accessories comprises a set of unique projections, and the identifier comprises an array of mechanical switches, the mechanical switches being configured to operably engage the unique projections to identify the toy accessory being associated with the identifier.

3. The language teaching toy system of claim 1, wherein each toy accessory includes a bottom portion and the identity portion of each toy accessory is disposed proximate to the bottom portion, each identity portion comprising at least one projection, the identifier includes a plurality of switches, the identity portion of each toy accessory engaging a different combination of switches than the identity portion of the other toy accessories.

4. The language teaching toy system of claim 1, wherein each of the toy accessories includes at least one visual indicia thereon, and upon identification of a particular toy accessory by the control system, the control system produces accessory-specific sensory stimulating output relating to the visual indicia.

5. The language teaching toy system of claim 4, wherein the visual indicia is one of a number, a word, and a color.

6. The language teaching toy system of claim 1, wherein each of the toy accessories comprises a unique shape, and upon identification of a particular toy accessory by the control system, the control system produces accessory-specific sensory stimulating output relating to the shape thereof.

7. The language teaching toy system of claim 1, wherein the base unit is configured as a portion of a toy store and the plurality of toy accessories are configured as items sold in a store.

8. The language teaching toy system of claim 7, wherein the base unit includes a simulated check-out area and the identifier is disposed proximate to the simulated check-out area.

9. The language teaching toy system of claim 1, wherein one of the at least two different languages is the native language of a country in which the system is distributed.

10. The language teaching toy system of claim 1, wherein the at least two different languages comprise English and Spanish.

11. A role-play learning toy comprising:
a base unit, the base unit including an electronic control system configured to produce sensory stimulating output through an output device, the base unit being configured to resemble a portion of a toy store that includes a simulated check-out area, the electronic control system including an identifier housed in the check-out area;
a plurality of toy accessories configured to resemble items sold in a store, each of the toy accessories including a unique identity portion, the identity portions being discernable by the identifier, the control system being operable to discretely identify the toy accessories via the operative association of the identity portion of an accessory with the identifier; and
wherein upon identification of a particular toy accessory by the identifier of the control system, the control system produces accessory-specific sensory stimulating output in a language that is native to a country in which the toy is distributed and in at least one other language.

12. The role-play learning toy of claim 11, wherein the identity portion of each of the accessories mechanically interacts with the identifier to discretely identify the toy accessory in operative association with the identifier.

13. The role-play learning toy of claim 11, wherein each of the toy accessories includes at least one visual indicia thereon, and upon identification of a particular toy accessory by the control system, the control system produces accessory-specific sensory stimulating output relating to the visual indicia.

14. The role-play learning toy of claim 13, wherein the visual indicia is at least one of a number, a word, and a color.

15. The role-play learning toy of claim 11, wherein each of the toy accessories comprises a unique shape, and upon identification of a particular toy accessory by the control system, the control system produces accessory-specific sensory stimulating output relating to the shape.

16. The role-play learning toy of claim 11, wherein the native language is English and the at least one other language is Spanish.

17. An output generating toy system comprising:
a first accessory, the first accessory including an identity portion;
a second accessory, the second accessory including its own identity portion, the identity portion of the second accessory being different than the identity portion of the first accessory;
a housing, the housing including an electronic control system, the electronic control system having an accessory receiving area including an identifier, and an output generating device, the identifier being configured to interact with the identity portion of the first accessory when the first accessory is associated with the identifier and to interact with the identity portion of the second accessory when the second accessory is associated with the identifier, the output generating device being configured to generate an output relating to the first accessory when the first accessory is associated with the identifier and to generate an output relating to the second accessory when the second accessory is associated with the identifier, the outputs relating to the first accessory and to the second accessory being in generated in at least two different languages.

18. The output generating toy system of claim 17, wherein the first accessory includes indicia, the output relating to the first accessory relates to the indicia of the first accessory, and the second accessory includes indicia different from the first accessory indicia, the output relating to the second accessory relates to the indicia of the second accessory.

19. The output generating toy system of claim 17, wherein the first accessory includes a bottom portion having at least two sides, the identity portion of the first accessory comprising a pattern of at least one projection, the pattern of first accessory identity portion being proximate to each of the at least two sides, the second accessory includes its own bottom portion having at least two sides, the identity portion of the second accessory comprising a pattern of at least one projection, the pattern of the second accessory being different than the pattern of the first accessory, the pattern of the second accessory identity portion being proximate to each of the at least two sides, and the identifier includes at least two switches, the patterns of the first accessory and the second accessory engaging different combinations of the at least two switches when the first accessory and the second accessory engage the identifier.

20. The output generating toy system of claim 17, wherein one of the at least two different languages is a native language to a country in which the system is distributed.
